(19) United States
(12) Patent Application Publication
(10) Pub. No.: US 2026/0005554 A1
(43) Pub. Date: Jan. 1, 2026

(54) LAMINATED CORE, MORE PARTICULARLY FOR A STATOR OF AN ELECTRIC MACHINE, AND METHOD FOR PRODUCING SAID LAMINATED CORE

(71) Applicant: voestalpine Stahl GmbH, Linz (AT)

(72) Inventor: Ronald Fluch, Linz (AT)

(21) Appl. No.: 18/881,072

(22) PCT Filed: Jul. 21, 2023
(86) PCT No.: PCT/EP2023/070376

§ 371 Date: Jan. 3, 2025

(30) Foreign Application Priority Data
Jul. 21, 2022 (EP) 22186352.5

(51) Int. Cl. H02K 1/12; H02K 9/19; H02K 15/027; H02K 15/0273

(52) U.S. Cl. CPC H02K 1/12; H02K 9/19; H02K 15/027; H02K 15/0273; H02K 2201/09

(57) ABSTRACT

A laminated core, more particularly for a stator of an electric machine, and method for producing said laminated core. The laminated core has several layers stacked one atop another, wherein the layers are each made up of either an individual sheet metal part or several sheet metal parts positioned next to one another and each sheet metal part has a protrusion and with the aid of these protrusions, the layers engage with one another. It is proposed, in the case of a single sheet metal part making up a layer, for the protrusion to be embodied as completely surrounding the longitudinal axis of the laminated core or, in the case of several sheet metal parts positioned next to one another making up a layer, for the protrusions of these sheet metal parts to be embodied as combining to completely surround the longitudinal axis of the laminated core.

### TECHNICAL FIELD

The invention relates to a laminated core, more particularly for a stator of an electric machine, and to a method for producing said laminated core with a plurality of layers stacked atop one another, wherein the layers are each composed of an individual sheet metal part or several sheet metal parts positioned next to one another, and each sheet metal part has a protrusion and with the aid of these protrusions, the layers engage with one another, and with a longitudinal axis of the laminated core extending through the center of the laminated core.

### PRIOR ART

A reduced size together with increased power density in laminated cores requires a cooling liquid to be pumped around them-which in turn requires that there be no gaps between the layers of stacked sheet metal parts. For example, it is known to bond stacked sheet metal parts to one another under pressure with a layer of hot-melt adhesive varnish between them. Nevertheless, parameter fluctuations in the process for producing the laminated core can negatively affect the properties of the hot-melt adhesive varnish layer or else other negative influencing factors can make it impossible to reliably rule out the formation of gaps-more particularly if there is a high fluid pressure on the laminated core. Laminated cores of this kind are therefore often unusable in high-performance applications with intensive cooling requirements.

It is also known (U.S. Pat. No. 4,578,853) in laminated cores to provide the sheet metal parts with hollow embossed protrusions by means of which the relevant layers of the laminated cores engage with one another.

### SUMMARY OF THE INVENTION

The object of the invention, therefore, is to modify the design of a laminated core of the type explained at the beginning such that it can be durably subjected to a liquid cooling, even at a high hydraulic pressure and is therefore universally usable.

The durability of the laminated core against liquid penetration between the layers can be improved if, in the case of an individual sheet metal part forming a layer, the projection is embodied as completely surrounding the longitudinal axis of the laminated core. Alternatively, the durability of the laminated core against liquid penetration between the layers can be improved if, in the case of several sheet metal parts positioned next to one another making up a layer, the protrusions of these sheet metal parts are embodied as combining to completely surrounding the longitudinal axis of the laminated core.

These protrusions embodied as completely surrounding the longitudinal axis of the laminated core (e.g.: center longitudinal axis) in both variants, namely in the stacks of sheet metal parts, can ensure a lack of gaps in these regions. In addition, they produce a kind of barrier between the layers in the laminated core-which even in gap-free laminated cores can ensure that they are able to withstand even higher hydraulic pressures, which is required, for example, with an external cooling of a stator laminated core in the high-performance sector.

In addition, such protrusions can be advantageously produced in the laminated core using known methods, as are known in clinching.

Preferably, each layer of the laminated core has one sheet metal part, which, in comparison to segmented layers—i.e. layers formed by several sheet metal parts positioned next to and touching one another—can always ensure a particularly gap-free, continuous, completely circumferential projection in a layer. As a result, maximum pressure resistance can be achieved with a laminated core with layers that are made up of individual sheet metal parts.

When using segmented layers, a sealing compound-advantageously a resin-based one—can be provided at abutting surfaces between the sheet metal parts that are positioned next to one another, which can further increase the pressure resistance, for example.

The laminated core according to the invention therefore not only can be subjected to rugged universal use for a liquid cooling, even at high hydraulic pressures, but can also be inexpensively and reproducibly manufactured.

Preferably, the protrusions are positioned in the outer third of the laminated core in order to thus be able to withstand the high hydraulic pressures that occur, for example with external cooling of the laminated core. The laminated core according to the invention is thus rugged enough to use even in high-performance applications with intensive cooling requirements.

The above is more particularly true, even if the protrusions are positioned in the region of the outer circumference of the laminated core. For example, the protrusions are spaced at most up to 10 mm from the outer circumference. This can minimize among other things the risk of a possible influence of the protrusions that engage with one another on the magnetic properties of the laminated core.

The design of the laminated core can also be simplified if the protrusions are each formed by a respective step in the sheet metal part, and wherein the outer edge of each sheet metal part forms a step bottom of the step.

Alternatively, it is conceivable for the protrusions to be each formed by a respective rib, more particularly a circular rib, in the sheet metal part. This can also ensure a sufficiently high barrier effect against the penetration of liquid-even at a comparatively high applied hydraulic pressure.

It is also conceivable for the protrusions to each have a protrusion height in the range from greater than or equal to 0.5 times to less than 2 times, more particularly 1 time, the thickness of the sheet metal part. In addition, protrusions embodied in this way can be provided on the sheet metal part comparatively easily. The sheet metal part can, for example, have a thickness of 0.1 to 1 mm, more particularly 0.2 to 0.5 mm.

More particularly, the invention can feature a glued laminate core. In this case, the sheet metal parts that make up the layers are integrally bonded to one another by means of an adhesive layer provided on the sheet metal parts, more particularly a thermosetting hot-melt adhesive varnish such as backlack. Preferably, the adhesive is provided over the entire surface of the sheet metal parts.

Particularly during the stacking of the sheet metal parts, the protrusions ensure that the adhesive is laden with pressure in more directions than only in the stacking direction-which reliably avoids the formation of bubbles between the layers. The glued laminated core is therefore particularly suitable for a liquid cooling and can ensure a high degree of durability even at comparatively high hydraulic pressures. Laminated cores of this kind can excel, for example, when used in high-performance applications with high cooling requirements.

Another stated object of the invention is to create a method that can be used to produce a liquid-cooled laminated core in a reproducible way.

The protrusions are produced in the metal sheet or sheet metal strip or in the sheet metal parts by means of sheet forming and the sheet metal parts are stacked, both of these in such a way that in the case of an individual sheet metal part, the protrusion on this individual sheet metal part is embodied as completely surrounding the longitudinal axis of the laminated core at the relevant position, or in such a way that in the case of several sheet metal parts positioned next to one another, the protrusions are embodied as combining to completely surround the longitudinal axis of the laminated core at the relevant position and because of these, an especially reliable barrier to liquid penetration can be reproducibly provided in the laminated core.

In addition, this method step can be provided with comparatively simple forming that is known even from clinching when stacking laminated cores-which also leads to handling advantages for the process. The method according to the invention therefore makes it possible to produce sheet metal packages that can durably withstand liquid cooling at comparatively high hydraulic pressures and this can be done reproducibly without significant additional effort.

Preferably, the protrusions are produced and the sheet metal parts are stacked, both in such a way that the protrusions are positioned in the outer third of the laminated core in order to thus produce a barrier, more particularly a barrier associated with the outer surface of the laminated core.

For example, the protrusions are positioned in the region of the outer circumference of the laminated core, which because of other dimensions, can further reduce the production cost of the method in comparison to protrusions positioned on the inside of the laminated core. If the protrusions are spaced at most 10 mm from the outer circumference, then this can further increase the reproducibility of the method. This is the case because it is necessary to further reduce the risk of negatively affecting the magnetic properties of the laminated core due to production tolerances in the manufacture of protrusions that engage with one another.

The reproducibility of the method can be further increased if the protrusions are produced as a step or rib.

The method can be simplified if the metal sheet or sheet metal strip or an outer edge of the sheet metal part is deep-drawn to form the step.

The protrusions can be manufactured in a more reproducible way if the metal sheet or sheet metal strip or the sheet metal part is hollow-embossed to form the rib, more particularly the circular rib.

Because the sheet metal parts securely engage with one another, it can be advantageous if the protrusions are each produced in the metal sheet or sheet metal strip with a protrusion height in the range from greater than or equal to 0.5 times to less than or equal to 2 times, more particularly 1 time, the thickness of the sheet metal part.

In a particularly reproducible way, the method enables the production of liquid-tight laminated cores in that a metal sheet or sheet metal strip with a more particularly thermosettable hot-melt adhesive varnish, more particularly backlack, is produced, wherein the hot-melt adhesive varnish is activated and the layers composed of sheet metal parts are thus integrally bonded to one another.

Preferably, a metal sheet or sheet metal strip with a more particularly thermosettable hot-melt adhesive varnish, more particularly backlack, is produced, which adhesive layer is provided on both of the two flat sides of the metal sheet or sheet metal strip. Preferably, the hot-melt adhesive varnish or adhesive layer is provided over the entire surface of the sheet metal parts. Preferably, the hot-melt adhesive varnish is activating during the stacking of the sheet metal parts and the layers made up of the sheet metal parts are thus integrally bonded in order to further accelerate the method.

### BRIEF DESCRIPTION OF THE DRAWINGS

The subject of the invention is shown in greater detail by way of example in the drawings based on several embodiment variants. In the drawings:

FIG. 1 shows a schematic view of a device for producing laminated cores,

FIG. 2a shows an enlarged partial view of a laminated core produced in accordance with FIG. 1,

FIG. 2b shows an enlarged partial view of a laminated core according to a second exemplary embodiment,

FIG. 3a shows a top view of the laminated core according to FIG. 2a, and

FIG. 3b shows a top view of a laminated core that is segmented in the layers—i.e. with several sheet metal parts positioned next to one another, which make up a layer-according to a third exemplary embodiment.

### DETAILED DESCRIPTION OF THE INVENTION

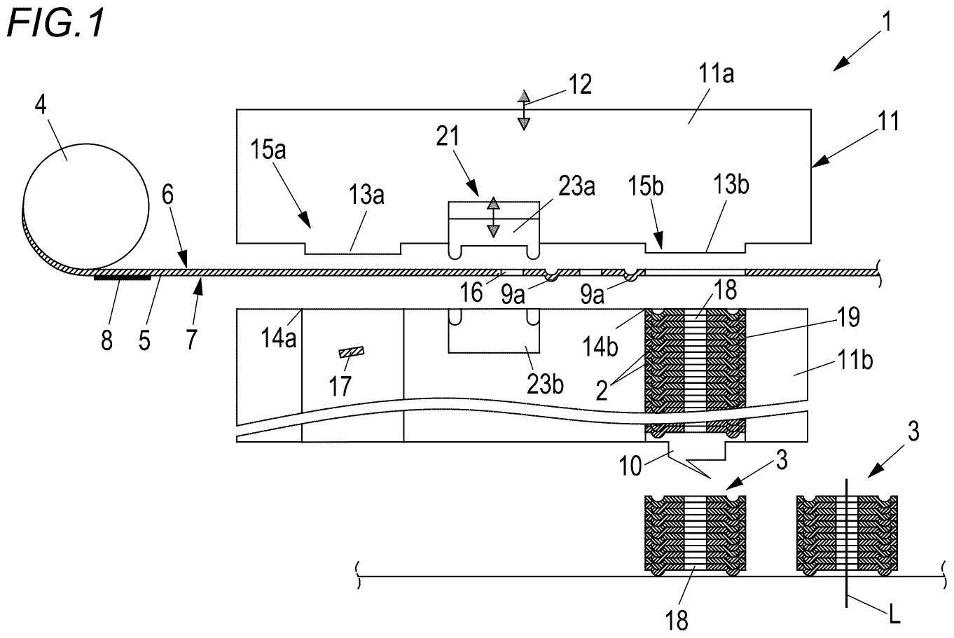

FIG. 1 schematically depicts an exemplary embodiment of a device 1 for implementing the method according to the invention. This device 1 is used for stacking stamped-out sheet metal parts 2 to form laminated cores 3. To this end, a sheet metal strip, namely composed of electrical strip is unwound from a coil 4 (or is taken from a sheet of electrical steel in the case of a metal sheet), which on one flat side 6 of the two flat sides 6, 7 has an adhesive layer 8 covering its entire surface, namely a heat-hardened hot-melt adhesive layer such as backlack. It is conceivable for an adhesive layer 8 covering the entire surface, namely a heat-hardened hot-melt adhesive layer such as backlack to be applied to both flat sides 6 and 7—but this is not shown.

The sheet metal strip 5 has a strip thickness or thickness d of 0.3 mm (millimeters).

Multiple sheet metal parts 2 are separated, more precisely stamped out, from the adhesive-coated sheet metal strip 5 with the aid of a stamping tool 11-a progressive stamping tool in the exemplary embodiment. Such a stamping-out can-generally speaking—be a cutting out, cutting off, notching, trimming, dividing by pushing out, etc.

As can be further inferred from FIG. 1, the stamping tool 11 executes a cut with a plurality of strokes 12. To this end, the cutters 13a, 13b in the upper tool 11a of the stamping tool 11 cooperate with the respective dies 14a, 14b of the lower tool 11b of the stamping tool 11 and thus embody two stamping stages 15a, 15b in the stamping tool 11.

With the first cutter 13a of the upper tool 11a a cut-out 16 is produced in the sheet metal strip 5, namely punched out from it, which can be seen from the punched-out leftover piece 17 in FIG. 1.

The cutter 13b separates the sheet metal part 2 from the sheet metal strip 5.

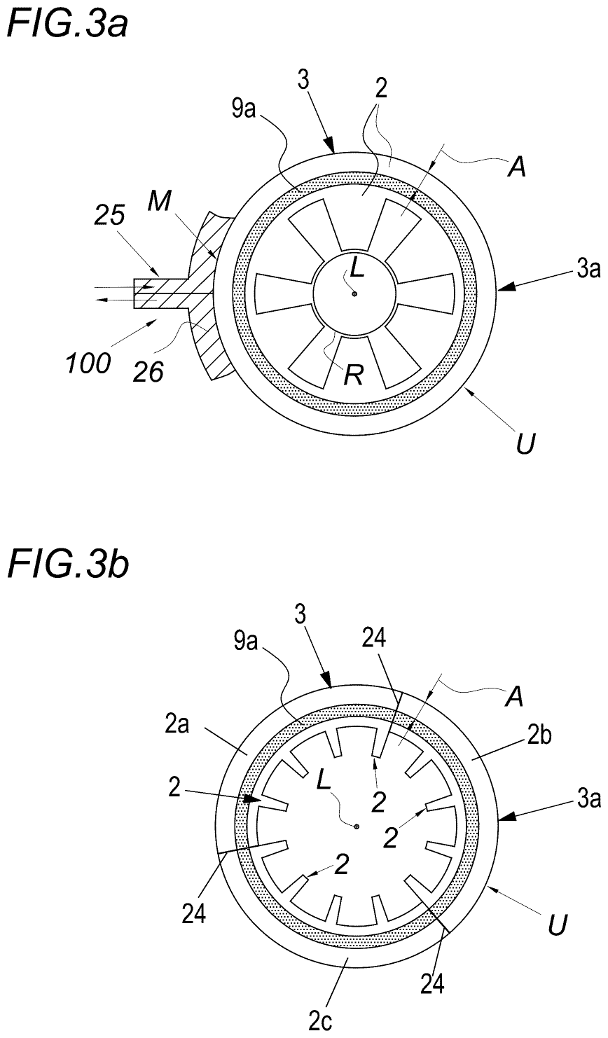

The cut-out 16 is provided in the sheet metal strip 5 for each separated sheet metal part 2 and therefore as a receptacle 18 in the laminated core 3 extends-centrally in the exemplary embodiment-through the laminated core 3. A rotor R of an electric machine 100 that is suggested in FIG. 3a is to be accommodated in this receptacle 18, in which the laminated core 3 serves as a stator.

Then the sheet metal parts 2 are stamped out by means of the stamping stage 15b, pushed into a stacking device 19 by the pressure of the upper tool 11a, and stacked therein. To this end, the stacking device 19 has a guide in the lower tool 11b. Also, as partially shown in FIG. 1, a brace 10 is provided in the guide.

The stacking device 19 is actively heated in order to activate the hot-melt adhesive layer of the sheet metal parts 2 and to produce an adhesive bond or an integral bond between the sheet metal parts 2. A laminated core 3 is laminated in this way.

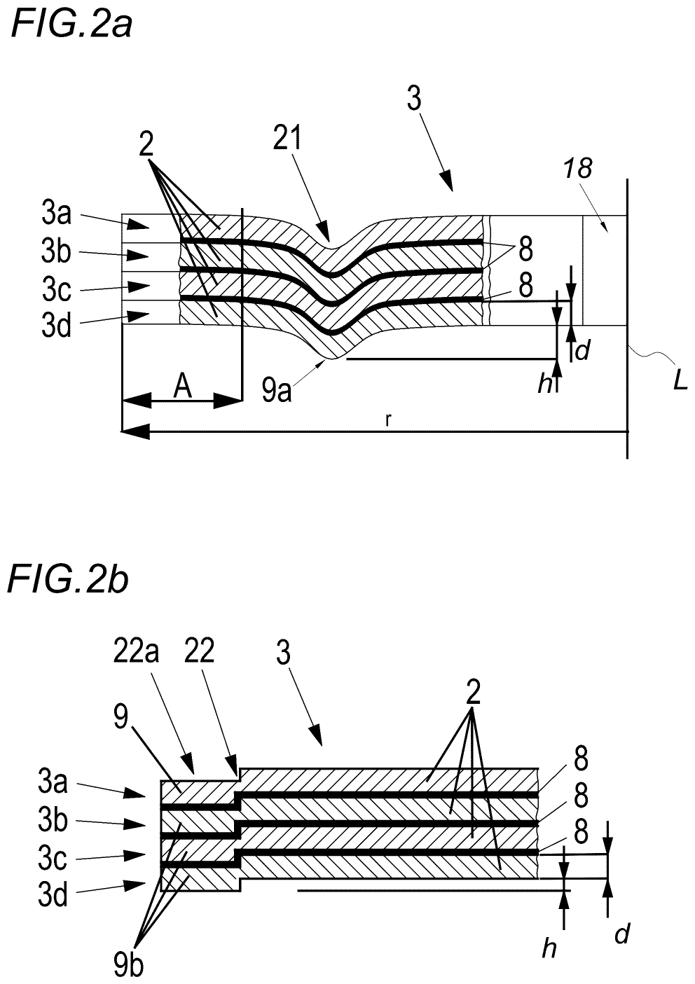

In order to achieve a media-tight laminated core 3, protrusions 9a, 9b are produced in the sheet metal strip 3 by means of sheet metal forming. These protrusions 9a, 9b are produced by means of hollow embossing in the forming stage 21 with a punch 23a and a die 23b. Each sheet metal part 2 of a laminated core 3 has such a protrusion 9a, 9b. The separated sheet metal parts 2 are then stacked to form a laminated core 3 with a plurality of layers 3a, 3b, 3c, 3d in such a way that multiple layers 3a, 3b, 3c, 3d of the laminated core 3 engage with one another by means of the protrusions 9a, 9b of the sheet metal parts 2—as can be seen especially well in FIGS. 2a and 2b. In this case, it is apparent how each protrusion 9a, 9b on one sheet metal part 2 engages in a recess that is preferably complementary thereto in an adjacent sheet metal part 2.

According to the invention, these protrusions 9a, 9b are particularly embodied-specifically the protrusions 9a, 9b as completely surrounding the longitudinal axis L of the laminated core 3—as is shown in FIGS. 2a, 2b, 3a, and 3b. In this regard, see the exemplary embodiments in FIGS. 1, 2a, and 2b. The layers 3a, 3b, 3c, 3d each have an individual sheet metal part 2. In the exemplary embodiments, the longitudinal axis L is the center longitudinal axis of the laminated core 3, i.e. a longitudinal axis L extending through the center of the laminated core 2. In the exemplary embodiment, this longitudinal axis L is, for example, also a symmetry axis of the laminated core.

If several sheet metal parts 2a, 2b, 2c that are positioned next to one another to make up a layer 3a, 3b, 3c, 3d are provided, as shown with three sheet metal parts 2a, 2b, and 2c in FIG. 3b, then the protrusions of these sheet metal parts 2a, 2b, 2c are embodied as combining to completely surround the longitudinal axis L of the laminated core 3. In addition, a resin-based sealing compound 24 is provided at the abutting surfaces between the sheet metal parts 2a, 2b, and 2c-which ensures a liquid-tight connection between the sheet metal parts 2a, 2b, and 2c.

This protrusion 9a, 9b that is embodied as completely surrounding in both embodiment variants and the mutual engagement of the layers 3a, 3b, 3c, 3d produce a barrier against a penetration of liquid. The laminated core 3 can therefore be durably subjected to a liquid cooling—for example water—with comparatively high hydraulic pressures. This means that the laminated core 3 is particularly suited for use as a stator, more particularly if a small size and high electric power are required from an electric machine.

Since the protrusions 9a, 9b extend in the vicinity of the outer circumference U of the laminated core 3, this laminated core 3 is also particularly suitable for a liquid cooling at the periphery of the laminated core 3. As shown in FIG. 2a, the protrusions 9a in FIG. 2a have a distance A from the outer circumference U of the laminated core 3 of at most 10 mm, whereas the protrusions 9b in FIG. 2b form the outer edge of the sheet metal parts 2.

As can also be inferred from FIGS. 2a and 2b, different embodiments of the protrusions 9a, 9b are possible.

According to FIG. 2a, the first protrusion 9a is embodied as a rib 21, namely a circular rib as shown. Such a circular rib can especially excel (in comparison to a box-shaped rib, trapezoidal rib, etc.) in providing a more uniform pressure impingement on the adhesive between the sheet metal parts 2 during the stacking.

FIG. 2b shows a second protrusion 9a, which is embodied as a step 22, whose step bottom 22a corresponds to the outer edge of the layers 3a, 3b, 3c, 3d.

In the structural embodiment of the protrusions 9a, 9b, it has turned out to be sufficient if the protrusions 9a, 9b each have a protrusion height h essentially equal to the thickness d of the sheet metal part 2. In this case, a sheet metal part 2 engages at most in an adjacent sheet metal part 2-which not only simplifies the laminated core 3, but also facilitates the method for stacking laminated cores.

FIG. 3a also schematically depicts an electric machine 100. The electric machine has a stator with the laminated core 3 according to the invention, which has a radius r. In addition, this electric machine 100 is associated with a cooling device 25, which guides the cooling liquid 26. The cooling device 25 directly acts on the outer surface M of the laminated core 3 with the cooling liquid 26, which thus comes into contact with the layers 3a, 3b, 3c, and 3d of the laminated core. The laminated core 2, which is sealed because of the surrounding protrusions 9a, 9b, withstands a liquid cooling even at a high hydraulic pressure and thus with small dimensions, permits high power densities in the electric machine 100.

It should be noted in general that the German expression “insbesondere” can be translated as “more particularly” in English. A feature that is preceded by “more particularly” is to be considered an optional feature, which can be omitted and does not thereby constitute a limitation, for example, of the claims. The same is true for the German expression “vorzugsweise”, which is translated as “preferably” in English.

1. A laminated core, in particular for a stator of an electric machine, comprising:
a plurality of layers stacked atop one another, wherein the layers are each composed of an individual sheet metal part or a plurality of sheet metal parts positioned next to one another, and each sheet metal part has a corresponding protrusion and with the aid of the corresponding protrusions, the plurality of layers engage with one another, and with a longitudinal axis of the laminated core extending through a center of the laminated core, wherein
in a case of a single one of the plurality of sheet metal parts making up one of the plurality of layers, the corresponding protrusion completely surrounds the longitudinal axis of the laminated core or
in a case of more than one of the plurality of sheet metal parts positioned next to one another making up one of the plurality of layers, the corresponding protrusions of these sheet metal parts combine to completely surround the longitudinal axis of the laminated core.

2. The laminated core according to claim 1, wherein the corresponding protrusions are positioned in an outer third of the laminated core.

3. The laminated core according to claim 2, wherein the corresponding protrusions are positioned in a region of an outer circumference of the laminated core, and are spaced at most 10 mm from the outer circumference.

4. The laminated core according to claim 1, wherein the corresponding protrusions are each formed by a respective step in the corresponding sheet metal part, and wherein an outer edge of the corresponding sheet metal part forms a step bottom of the respective step.

5. The laminated core according to claim 1, wherein the corresponding protrusions are each formed by a respective rib, circular rib in the corresponding sheet metal part.

6. The laminated core according to claim 1, wherein the corresponding protrusions each have a protrusion height in a range from greater than or equal to 0.5 times to less than 2 times a thickness of the corresponding sheet metal part.

7. The laminated core according to 6 claim 1, wherein the plurality of sheet metal parts that make up the plurality of layers are integrally bonded to one another by an adhesive layer provided on the sheet metal parts.

8. A method for producing the laminated core according to claim 1, comprising:
producing the corresponding protrusions in a metal sheet or sheet metal strip by of sheet forming,
subsequently separating the plurality of sheet metal parts from the metal sheet or sheet metal strip, wherein a plurality of the sheet metal parts each have at least one of the corresponding protrusions, and then
stacking the plurality of separated sheet metal parts to form a laminated core having the plurality of layers positioned one atop the other in such a way that with the aid of the corresponding protrusions in the plurality of sheet metal parts, the plurality of layers of the laminated core engage with one another, wherein
the corresponding protrusions are produced in the metal sheet or sheet metal strip or in the plurality of sheet metal parts of sheet forming and the plurality of sheet metal parts are stacked, both in such a way that
in the case of a single one of the plurality of sheet metal parts forming a layer one of the plurality of layers, the corresponding protrusion completely surrounds the longitudinal axis of the laminated core, or in such a way that
in the case of more than one of the plurality of sheet metal parts positioned next to one another forming a layer one of the plurality of layers, the corresponding protrusions of these sheet metal parts combine to completely surround the longitudinal axis of the laminated core.

9. The method according to claim 8, wherein the corresponding protrusions are produced and the plurality of sheet metal parts are stacked, both in such a way that the corresponding protrusions are positioned in an outer third of the laminated core.

10. The method according to claim 9, wherein the corresponding protrusions are positioned in a region of an outer circumference of the laminated core, and are spaced at most 10 mm from the outer circumference.

11. The method according to claim 8, wherein the corresponding protrusions are produced in the form of a step or rib.

12. The method according to claim 11, wherein the metal sheet or sheet metal strip or an outer edge of each of the plurality of sheet metal parts is deep-drawn to form the step.

13. The method according to claim 11, wherein the metal sheet or sheet metal strip or each of the plurality of sheet metal parts is hollow-embossed to form the rib.

14. The method according to claim 8, wherein the corresponding protrusions are each produced in the metal sheet or sheet metal strip with a protrusion height in a range from greater than or equal to 0.5 times to less than 2 times a thickness of the corresponding sheet metal part.

15. The method according to claim 8, comprising providing the metal sheet or sheet metal strip with a thermosetting hot-melt adhesive varnish, and activating the hot-melt adhesive varnish during the stacking of the plurality of separated sheet metal parts, and the activating of the hot-melt adhesive varnish integrally bonds the plurality of layers made up of the plurality of sheet metal parts to one another.

16. An electric machine with a stator, comprising the laminated core according to claim 1 and a cooling device, which guides a cooling liquid that directly acts on an outer surface of the laminated core.

17. The laminated core according to claim 6, wherein the corresponding protrusions each have a protrusion height that is approximately equal to the thickness of the sheet metal part.

18. The laminated core according to claim 7, wherein the adhesive layer is a thermosetting hot-melt adhesive varnish.

19. The method according to claim 13, wherein the rib is a circular rib.

20. The method according to claim 15, wherein the thermosetting hot-melt adhesive varnish is backlack.
